(19) United States
(12) Patent Application Publication
(10) Pub. No.: US 2005/0226480 A1
(43) Pub. Date: Oct. 13, 2005

(54) Compact device for anamorphically imaging the surface of objects using a reflecting prism

(76) Inventors: Guenther Benedix, Jena (DE); Mathias Schulz, Rothenstein (DE); Eberhard Piehler, Lehesten (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/515,237

(22) PCT Filed: Apr. 4, 2003
(86) PCT No.: PCT/EP03/03527

§ 371 Date: May 27, 2005

(30) Foreign Application Priority Data
May 22, 2002 (DE) 102 23 107.9

(51) Int. Cl. G06K 9/00; G06T 7/00; G06K 7/10; G06K 9/20

(52) U.S. Cl. 382/127; 382/321

(57) ABSTRACT

The invention concerns a device for the graphical reproduction of the surface of objects, in which additional prisms are placed in the path of the detection beam between a scanning prism and an optoelectric sensor. Such optical devices are particularly suited for taking fingerprints. At least one of the additional prisms located in the path of the detection beam is designed as a reflecting prism, which has an incoming beam surface and an exiting beam surface that can be located together on a prism surface, and a reflective back area onto which the incoming light falls inside the prism.

### RELATED APPLICATIONS

This application claims priority to PCT Application No. PCT/EP03/03527, filed Apr. 4, 2003, and German Application No. DE 102 23 107.9, filed May 22, 2002.

### BACKGROUND OF THE INVENTION

1. Field of the Invention

The invention concerns a device to graphically reproduce the surface of objects in which the objects are placed on the scanning area of a scanning prism, and in which there is an array of further prisms in the path of the detection beam between the scanning prism and an optoelectronic sensor. Such optical devices are particularly well suited for taking finger-prints.

2. Background

Processes and devices for reproducing objects using the optical principle of the disturbed total reflection are known from the state of the art.

In this connection, DE 34 21 220 C2 describes a “device for the distortion-free graphical reproduction of objects placed at an oblique angle to the scanning area,” in which a reflective prism is used as scanning prism. The object must be pressed from the outside onto a scanning area of the scanning prism, while, inside the scanning prism, the light is aimed at the scanning area. The light is reflected inside the scanning prism by the scanning area and in the process collects image information of the surface segment of the object resting on it.

This device, which serves in particular to collect, examine and identify fingerprints, is characterized by the fact that there are two deflecting prisms between the scanning prism and the face-side end section of the device, one of which serves to anamorphotically enlarge the object to be reproduced and the other to compensate for astigmatism, and that there is a lens that precedes an optical reproduction device or an optical analysis device.

The two deflecting prisms in combination are intended to facilitate anamorphotic enlargement without astigmatism when the planes of the image and the object are close, resulting in a low-distortion and high-resolution picture.

However, a significant disadvantage of this device is the course of the path of the beam caused by the use of the deflecting prisms; thus, only instruments with relatively large rated volume and in particular large rated heights are possible following this principle.

To that extent, this device does not satisfy the often-voiced call for a compact, space-saving device design.

### SUMMARY OF THE INVENTION

Against that background, the invention has the purpose of improving the device described above in such a way that such devices can be designed with reduced rated volume and, in particular, reduced rated height.

The invention solves this problem in that at least one of the other prisms arranged in the path of the deflection beam is designed as a reflective prism with an incoming beam area, a reflective back area onto which the incoming light falls inside the prism, as well as an exiting beam surface.

Since the optical path now is no longer guided through deflecting prisms as in prior art because of the use of reflective prisms, a substantial reduction in the rated height of the devices built according to the characteristics of the invention becomes possible.

The reflective prisms can be designed to great advantage in such a way that the incoming beam surface and the exiting beam surface are located in a common prism area, so that the detection beam exits the prism through the same area through which it enters the prism.

According to the invention, both the prism for anamorphotic enlargement and the prism to compensate for astigmatism can be designed as reflective prisms. However, embodiments are also conceivable in which either only one or the other prism is designed as a reflective prism.

In this way, it is possible to make the device more compact as needed even as the length of the optical path remains the same.

Reflective prisms can, for example, be manufactured by providing a surface opposite the incoming beam surface of the prism, described as the back area in the invention, a mirrored surface or by pasting this area to a mirrored surface.

In a preferred embodiment of the device according to the invention there is also at least one plane mirror in the path of the detection beam between the scanning prism, and a lens that precedes the optoelectronic sensor to deflect the path of the beam for the purpose of bending.

This bending serves to further reduce the distance between the scanning prism and the optoelectronic sensor while, at the same time, maintaining the required optical path by aiming the beam, for example, from one prism first to a plane mirror and then from the latter to another prism, or from the plane mirror to at least one other plane mirror, forming in the process a more or less acute angle with the connecting line between the prisms.

In tested and tried embodiments of the invention there are two, or even three, plane mirrors between the prism for anamorphotic enlargement and the prism to compensate for the astigmatism.

Between the prism to compensate for the astigmatism and the optoelectronic sensor is a lens from which the detection beam is aimed at the optoelectronic sensor. In an additional embodiment of the invention, it is also possible to place at least one other optical element between the lens and the optoelectronic sensor that deflects the beam yet again and thereby allows for a reduction in the rated length of the device. Such an optical element is preferably a plane mirror.

The scope of the invention also allows for the replacement of the prism to compensate for astigmatism by a cylinder lens in order to achieve a technically desired effect.

### BRIEF DESCRIPTION OF THE DRAWINGS

The invention will be explained in more detail in the examples of embodiment that follow. The respective drawings show

FIG. 1 depicts the beam of a first exemplary embodiment in which the prism for anamorphotic enlargement is designed as a reflective prism that precedes two plane mirrors for bending the beam,

FIG. 2 depicts a second exemplary embodiment in which the prism for anamorphotic enlargement is also designed as a reflective prism, followed, however, by three plane mirrors for bending the beam,

FIG. 3 depicts an exemplary embodiment with two plane mirrors between which the beam repeatedly bounces back and forth.

### DETAILED DESCRIPTION

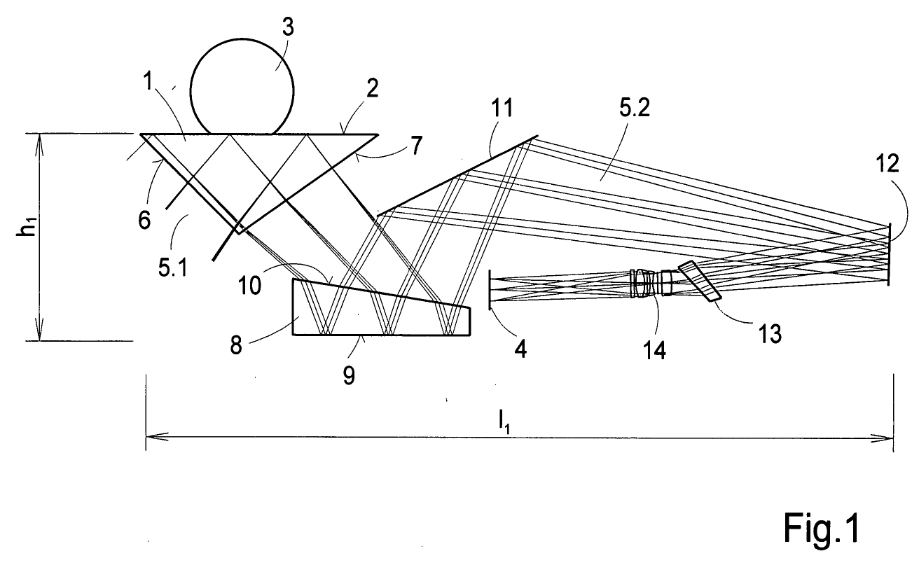

FIG. 1 shows a scanning prism 1 that has a scanning area 2 onto which an object 3 is placed. The surface section of the object 3 resting on it is to be reproduced on the receiving area of an optoelectronic sensor 4, for example the CCD sensor of an optoelectronic camera.

For this purpose, light is beamed in one light beam path 5.1 through an incoming beam surface 6 into the scanning prism 1 and reflected inside the scanning prism 1 off the scanning area 2. In the process, the light registers image information, for example the papillary line pattern of a finger resting on it, exits again from the scanning prism 1 in one detection beam 5.2 through the exiting beam surface 7 and arrives at another prism 8 for anamorphotic enlargement.

The prism 8 of the invention is designed as a reflective prism, and thus has a mirrored surface on the back area 9. Because of this, the detection beam 5.2 entering into prism 8 through the prism area 10 does not exit again from the opposite surface and is only deflected in the process, as is usual with the current state of the art, but is reflected off the back area 9 and exits again through the prism area 10.

This has the advantage that only small prism angles are necessary because of the mirrored surface, which makes bending possible already at that stage.

In its further course, the detection beam 5.2 falls on a first reflector 11, is deflected by it in the direction of a second reflector 12 and falls on a prism 13 that serves to correct the astigmatism and is designed as a deflecting prism in this case.

Between the prism 13 and the optoelectronic sensor 4 is a lens 14 from which the detection beam 5.2 is aimed at the receiving area of the optoelectronic sensors 4.

Here, l₁ stands for the rated length and h₁ stands for the rated height of an optical device designed following the characteristics of the invention. It can be seen that the rated length l₁ is much shorter than the optical path of the detection beam 5.2 from the scanning prism 1 to the optoelectronic sensor 4, and that the rated height h₁ is substantially less than what is known from prior art devices in which the detection beam is at this spot carried through a deflecting prism.

The reduction in the rated length l₁ and especially in the rated height h₁ is achieved by designing the prism 8 as a reflective prism and by repeatedly changing the direction of the detection beam 5.2 at the reflectors 11 and 12.

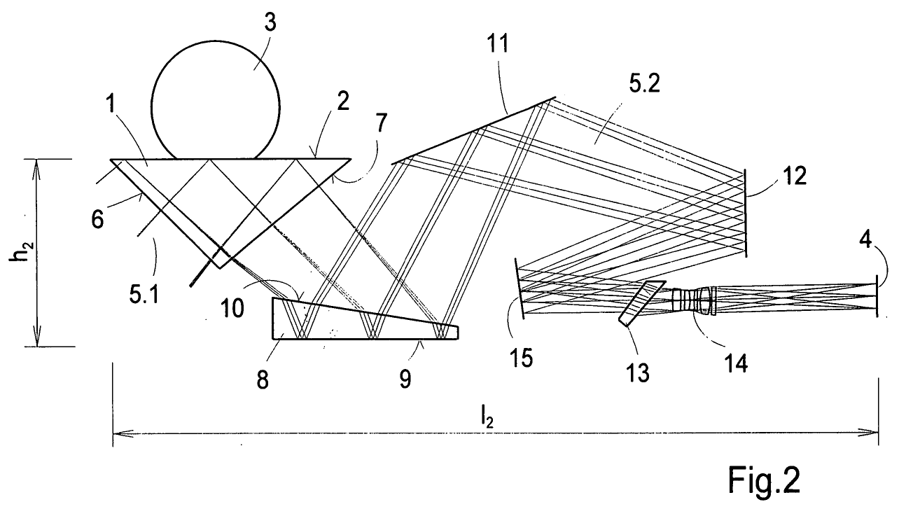

Unlike the possible embodiments of the invention according to the previous example, FIG. 2 shows an exemplary embodiment that features not two but three reflectors 11, 12 and 15 along the path of the detection beam 5.2 between prism 8 and the deflecting prism 13. Because of the additional change in direction of the detection beam 5.2 via the reflector 15 the device can be made even more compact by influencing the rated length l₂ and the rated height h₂.

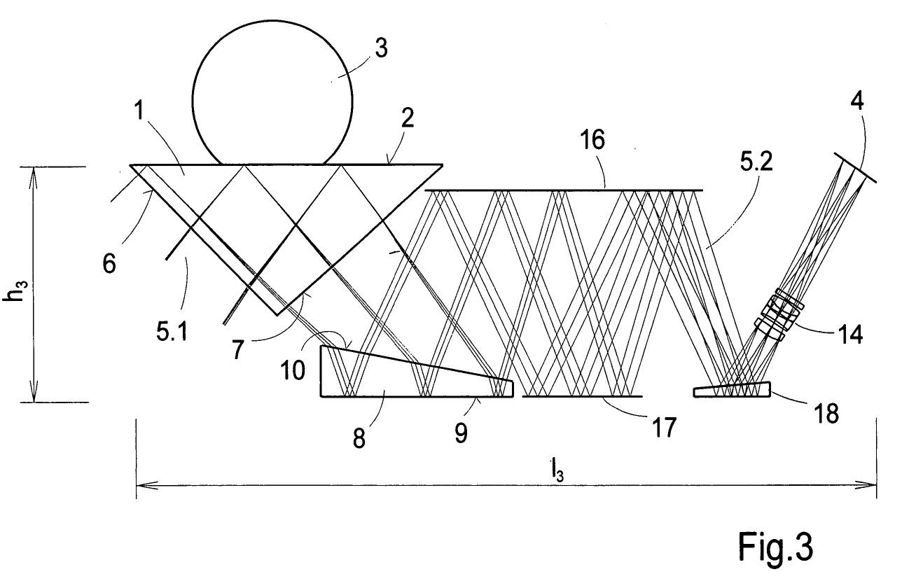

In the third exemplary embodiment according to FIG. 3, the prism 8 precedes two reflectors 16 and 17, between which the detection beam 5.2 repeatedly bounces back and forth, leading to a reduction in the rated length l₃ and the rated length h₃ and contributing thus to a more compact device. Moreover, unlike the two previous examples of embodiment, the prism for correcting the astigmatism is designed not as a deflecting prism but as a reflective prism 18.

In another conceivable example, not illustrated here, another plane mirror, which would deflect detection beam 5.2 one more time, thus making another shortening of the rated length of the device possible, can be placed between the lens 14 and the optoelectronic sensor 4.

### LIST OF REFERENCE NUMBERS

1 Scanning prism

2 Scanning area

3 Object

4 Optoelectronic sensor

5.1 Light beam

5.2 Detection beam

6 Incoming beam surface

7 Exit beam surface

8 Prism

9 Back area

10 Prism area

11, 12 Reflectors

13 Deflecting prism

14 Lens

15 Reflector

16, 17 Reflectors

18 Prism

1. A device for the graphical reproduction of objects comprising:
a scanning prism including a scanning area on which the objects are placed, and
an array of prisms arranged in a path of the detection beam between the scanning prism and an optoelectronic sensor,
wherein at least one of the prisms of the array is a reflective prism including with an incoming beam surface and an exiting beam surface, and a reflective back surface onto which incoming light falls inside the prism.

2. A device according to claim 1, further comprising a first prism adapted to anamorphotically influence the path of the detection beam and a second prism adapted to compensate for astigmatism, wherein at least one of the first prism or the second prism is a reflective prism.

3. A device according to claim 1, wherein the incoming beam surface and the exiting beam surface are on a common prism surface.

4. A device according to claim 1, wherein the at least one reflective prism comprises a mirrored surface on a back area.

5. A device according to claim 1, further comprising at least one plane mirror arranged in the path of the deflection beam to deflect the path of the beam.

6. A device according to claim 5, wherein at least two adjacent plane mirrors are arranged between a first prism to anamorphotically influence the detection beam and a second prism to compensate for astigmatism.

7. A device according to claim 6, comprising three adjacent plane mirrors.

8. A device according to claim 1, wherein the optoelectronic sensor is preceded by a lens, and wherein at least one optical element is arranged between the lens and the optoelectronic sensor to deflect the path of the detection beam.

9. A device according to claim 8, wherein the optical element comprises a cylinder lens.

10. A device according to claim 8, wherein the optical element comprises a plane mirror.

11. A device for graphical reproduction of objects comprising:
a scanning prism including a scanning surface onto which the objects may be placed; and
an array of prisms arranged in a path of a detection beam between the scanning prism and an optoelectronic sensor;
in which at least one of the prisms in the array comprises a reflective prism including an incoming beam surface, an outgoing beam surface, and a reflective surface onto which an incoming beam falls within the prism.

12. The device according to claim 11, further comprising an anamorphotic prism in the path of the detection beam and an astigmatism compensating prism in which at least one of the anamorphotic prism and the astigmatism compensating prism is a reflective prism.

13. The device according to claim 12, in which the incoming beam surface and the outgoing beam surface are the same surface.

14. The device according to claim 11, in which the reflective prism comprises a mirrored reflective surface.

15. The device according to claim 11, further comprising at least one plane mirror arranged in the path of the detection beam to deflect the path of the beam.

16. The device according to claim 12, further comprising at least two adjacent plane mirrors arranged between the anamorphotic prism and the astigmatism compensating prism.

17. The device according to claim 16, comprising three adjacent plane mirrors.

18. The device according to claim 11, further comprising a lens preceding the optoelectronic sensor and an optical element arranged between the lens and the optoelectronic sensor.

19. The device according to claim 11, in which the optical element comprises a cylindrical lens.

20. The device according to claim 11, in which the optical element comprises a plane mirror.

21. A method for graphical reproduction of objects comprising the steps of:
placing an object to be scanned onto a scanning surface of a scanning prism;
directing an illumination beam toward the scanning surface and receiving a reflected detection beam along a path;
placing an array of prisms in the path of the detection beam between the scanning prism and an optoelectronic sensor; and
selecting at least one of the prisms in the array to comprise a reflective prism including an incoming beam surface, an outgoing beam surface, and a reflective surface onto which an incoming beam falls within the prism.

22. The method according to claim 21, further comprising the steps of placing an anamorphotic prism and an astigmatism compensating prism in the path of the detection beam and selecting at least one of the anamorphotic prism and the astigmatism compensating prism to be a reflective prism.

23. The method according to claim 21, further comprising the step of making the incoming beam surface and the outgoing beam surface are the same surface.

24. The method according to claim 21, further comprising the step of mirror coating the reflective surface of the reflective prism.

25. The method according to claim 21, further comprising the step of placing at least one plane mirror in the path of the detection beam to deflect the path of the beam.

26. The method according to claim 22, further comprising the step of placing at least two adjacent plane mirrors between the anamorphotic prism and the astigmatism compensating prism.

27. The method according to claim 22, further comprising the step of placing three adjacent plane mirrors between the anamorphotic prism and the astigmatism compensating prism.

28. The method according to claim 21, further comprising the step of placing a lens preceding the optoelectronic sensor and placing an optical element arranged between the lens and the optoelectronic sensor.

29. The method according to claim 21, in which the optical element comprises a cylindrical lens.

30. The method according to claim 21, in which the optical element comprises a plane mirror.
